(19) United States
(12) Patent Application Publication
(10) Pub. No.: US 2020/0299021 A1
(43) Pub. Date: Sep. 24, 2020

(54) ATTACHMENT FOR GARDENING EQUIPMENT FOR STORING FLUIDS

(71) Applicant: JEWGENT, INC., Sarasota, FL (US)

(72) Inventor: LONNIE BOHRER, Sarasota, FL (US)

(73) Assignee: JEWGENT, INC., Sarasota, FL (US)

(21) Appl. No.: 16/824,890

(22) Filed: Mar. 20, 2020

Related U.S. Application Data
(60) Provisional application No. 62/821,560, filed on Mar. 21, 2019.

(51) Int. Cl. B65D 1/02; A01G 3/06

(52) U.S. Cl. CPC B65D 1/0223; B65D 2501/0081; A01G 3/06

(57) ABSTRACT

An attachment for a gardening equipment, which includes a cylindrical structure, including: a housing including a hollow interior defining a reservoir for storing fluid; a channel formed along a length of the housing; a pair of protrusions including a first protrusion and a second protrusion, each of the first and second protrusions being juxtaposed relative to one another and extending along a length of the channel; and wherein the first protrusion and the second protrusion defines a gap therebetween, the gap defining an unbiased width and a second width which is greater than the first width during placement of the cylindrical structure of the gardening equipment within the channel formed along the length of the housing.

### CROSS REFERENCE TO RELATED APPLICATIONS

This application relates to, and claims priority from, U.S. Prov. Pat. No. 62/821,560, filed on Mar. 21, 2019, the entire contents of which are incorporated herein by reference.

### BACKGROUND OF THE INVENTION

### Field of the Invention

The present invention generally relates to an attachment for gardening equipment for storing fluids, and more particularly, for an attachment that includes a reservoir for containing fluid (e.g., fuel or beverage).

### Description of the Related Art

Gardening and lawnmowing often involve the use of specialized machinery, such as, handheld stick equipment (e.g., string trimmers, edgers, and shaft hedge trimmers). Such equipment typically uses fuel such as gasoline. As the machinery often has high rates of fuel consumption and relatively small fuel tanks, when operating such machinery on large plots of land, refueling may be necessary prior to the completion of a job.

In addition, because gardening and lawnmowing is relatively labor intensive, the operators of the machinery exert a lot of energy. As with any labor-intensive activity that is physically strenuous, it is important to remain hydrated. However, carrying beverages while also needing to have one's hands available to operate the machinery may be difficult or inconvenient.

The presently disclosure addresses the above discussed disadvantages of the conventional art.

### ASPECTS AND SUMMARY OF THE INVENTION

An attachment for a gardening equipment may include: a cylindrical structure, including: a housing including a hollow interior defining a reservoir for storing fluid; a channel formed along a length of the housing; a pair of protrusions including a first protrusion and a second protrusion, each of the first and second protrusions being juxtaposed relative to one another and extending along a length of the channel; and wherein the first protrusion and the second protrusion defines a gap therebetween, the gap defining an unbiased width and a second width which is greater than the first width during placement of the cylindrical structure of the gardening equipment within the channel formed along the length of the housing.

The housing is formed from a material that is capable of small deflections such that when the cylindrical structure is inserted into the channel, the channel flexes to accommodate the cylindrical structure and grips the cylindrical structure. The housing may have a unitary structure.

A pair of opposing protrusions may extend lengthwise along a length of the channel, the pair of opposing protrusions configured to secure the cylindrical structure within the channel when the cylindrical structure is placed within the channel. The channel may define an arc defining a nadir. The partially hollow interior may define a reservoir for storing fluid is positioned adjacent to the nadir of the arc and does not extend along opposing sides of the arc. The housing may include a pair of tapered surfaces at opposing ends of the channel, the pair of tapered surfaces tapering toward a midpoint of length of the channel, thereby providing surfaces that may be grasped when removing the attachment from the gardening equipment to facilitate a quicker detachment therefrom.

These and other aspects of the present disclosure are more fully described hereinbelow with reference to the accompanying figures.

### BRIEF DESCRIPTION OF THE DRAWINGS

FIG. 1 is a perspective view of a string trimmer showing a fluid storage holder in accordance with the present disclosure partially secured thereto.

FIG. 2A is a perspective view of a fluid storage holder in accordance with the present disclosure.

FIG. 2B is a side view of the fluid storage holder of FIG. 3A.

FIG. 3A is a perspective view of another fluid storage holder in accordance with the present disclosure.

FIG. 3B is another perspective view of the fluid storage holder of FIG. 3A.

FIG. 4 is a perspective view of a cap configured to releasably cap an opening of the fluid storage holders of FIGS. 2A-3B.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale.

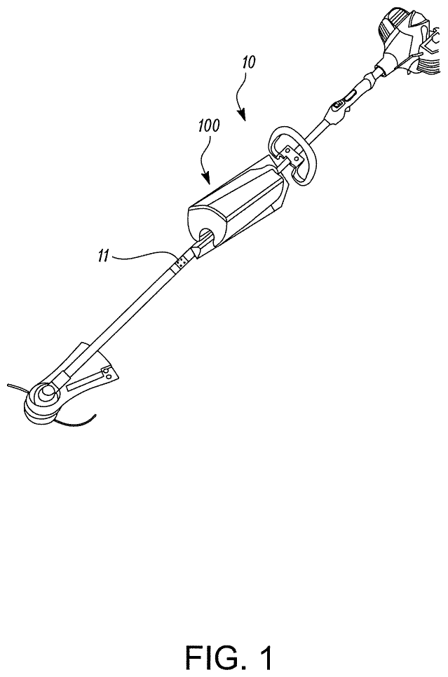

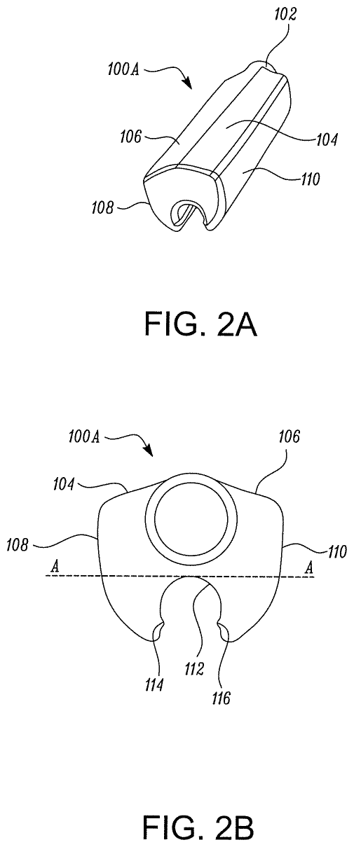

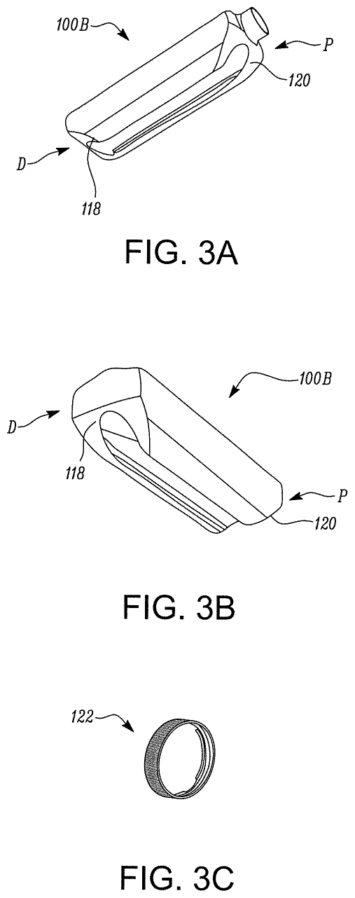

Embodiments of fluid storage holders 100, and the use thereof, are described with respect to FIGS. 1-4. Said fluid storage holders are referred to generally as fluid storage holders 100. A first embodiment of a fluid storage holder 100A is shown in FIGS. 2A-2B and a second embodiment of a fluid storage holder 100B is shown in FIGS. 3A-3B. The fluid storage holders 100A and 100B include many of the same features and only differ in the ways that are discussed herein.

Handheld stick equipment, such as a string trimmer 10 which is shown in FIG. 1 typically include an elongated, tube-like or cylindrical structure 11 onto which the presently disclosed fluid storage holder 100 may be releasably coupled. Other examples of such handheld stick equipment may include edgers and shaft hedge trimmers.

As discussed, the fluid storage holders 100 are configured to be releasably secured to a tubular structure. Any structure having an appropriate configuration (e.g., dimension and shape) corresponding to attachment means of the fluid storage holder 100 may be utilized for releasably coupling the fluid storage holder 100 to the gardening equipment. As discussed above, the gardening equipment 10 include tubular structures 11 and such structures may be a suitable spot for which to secure the fluid storage holders 100 to the gardening equipment 10, as shown in FIG. 1A-1B. In addition, as shown in FIG. 2, a conventional lawnmower 20 is shown which includes a frame 22 which may have a tubular or cylindrical shape to which the fluid storage holder 100 may be releasably secured.

A first embodiment of a fluid storage holder 100A is described with respect to FIGS. 2A-2B. As shown best in FIGS. 2A-2B, the fluid storage holder 100A includes an annulus 102 which leads to the hollow interior or reservoir of the fluid storage holder 100A.

The fluid storage holder 100A may include a channel 112 that extends along the length of the fluid storage holder 100A. The channel 112 may have a semi-annular shape such that when a tube or cylinder (e.g., a tube or cylinder of gardening machinery or device such as the gardening equipment 10 or the lawnmower 20) is placed within the channel 112, the channel 112 approximates the shape of the tube or cylinder of the gardening machinery or device. The fluid storage holder 100A may be formed from a plastic or polymer or metal and may be integrally formed. Preferably, the material forming the fluid storage holder 100A is capable of small deflections such that when the tube of the machinery is pushed within the channel 112, the channel 112 flexes to accommodate the tube and snuggly receives the tube within the channel 112. Preferably, the dimension of the channel 112 may be slightly smaller than that of the tube such that during insertion of the tube into the channel 112, the channel 112 flexes and squeezes the tube therein as the channel 112 is biased toward its initial slightly smaller dimension, thereby tightly securing the fluid storage holder 100A along the length of the tube.

In addition, a first protrusion 114 and a second protrusion 116 may extend along the length of the channel 112 such that during insertion of the tube, the tube pushes against the first protrusion 114 and the second protrusion 116 and causes a gap between the first protrusion 114 and the second protrusion 116 to increase somewhat in width. Upon urging of the tube of the machinery to enter the channel 112, the tube of the machinery ultimately clears the protrusions 114, 116, approximates the channel 112 (i.e., lies relatively flush against the curve of the channel 112), and the gap between the first and second protrusions 114, 116 lessens as the material forming the channel biases the first and second protrusions 114, 116 back toward the initial, undeformed state.

The fluid storage holder 100A may be shaped generally or partially as a polygon having a plurality of sides 104, 106, 108, and 110; however, other shapes or configurations are within the scope and spirit of the present disclosure. The edges between the sides 104, 106, 108, 110 may be rounded such that there are no sharp edges for both aesthetic and safety reasons. The shape of the fluid storage holder 100A, as well as other visual indicia such as color may provide an indication as to the contents of the fluid or liquid contained within the fluid storage holder 100A. In addition, or alternatively, the first storage holder 100A may be partially or entirely formed from a clear or translucent material such that both the type and volume of the contents contained therein can be readily ascertained.

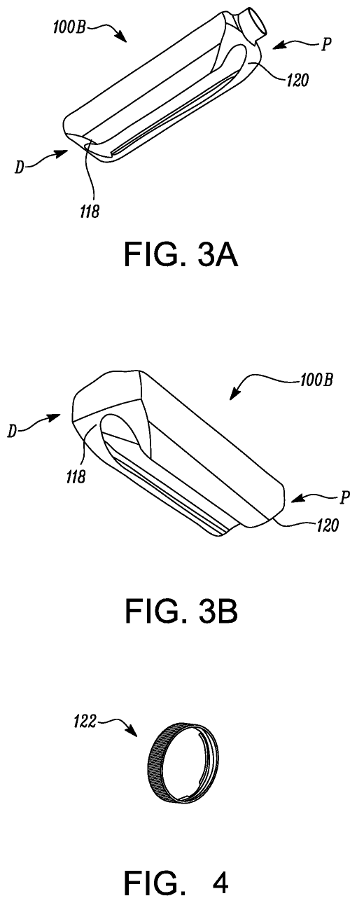

Another fluid storage holder 100B, as shown in FIGS. 4A-4B, except that surfaces 118 and 120 at opposing ends of the holder 100B (i.e., the surface 120 is near a proximal end P and the surface 118 is near a distal end D) may be tapered or be angled from the proximal end P and the distal end D in a direction toward the center of the fluid storage holder 100B. These tapered surfaces 118, 120 may provide a distinguishing shape from the other fluid storage holder 100A and may also provide surfaces on which a user may provide a pulling force to disengage the fluid storage holder 100B from the tube of the gardening machinery to which the fluid storage holder 100B had been secured.

As discussed, both the fluid storage holder 100A and 100B have substantially or partially hollow interiors or reservoirs in which fluid or liquid may be contained and include an annulus 102 (which may be of any shape) which serves as an inlet/outlet to/from the hollow interior or reservoir. As shown in FIG. 5, a cap 122, which has a corresponding shape to the annulus 102 is illustrated; the cap 122 may be releasably secured to the annulus 102.

In some embodiments, the fluid storage holders 100A and 100B may be partially hollow to form the reservoir and/or may include an internal lining that lines the reservoir walls or a separate bottle disposed within the housing and contained within the reservoir. For example, the reservoir may be lined with a plastic or a glass lining or another lining for hygienic reasons. For example, the lining may have antimicrobial properties when drinking fluids or stored therein or for example, in cases where fuel may be stored, the lining may have anticorrosive properties or may serve to strengthen or prevent puncture of the reservoirs.

In some embodiments, the hollow interior forming the reservoir may be disposed in a position that is adjacent relative to a nadir of the channel 112 such that when the channel 112 is flexed, flexing of the reservoir is minimized such that, for example, in cases where there may be a glass or plastic or other lining, the lining is not weakened over time from such usage and flexing of the channel 112. In other words, as shown in FIG. 2B, the housing may be divided into an area above line A-A which defines the reservoir within the housing and another area along the sides of the channel 112, thereby minimizing flexing of the reservoir and the potential for damage to any lining or glass which may be lining the reservoir.

During use, the fluid storage holder 100A, 100B may be snap fit onto a suitable tubular or cylindrical structure of the gardening machinery or equipment to releasably secure the fluid storage holder 100A, 100B to the equipment. Pulling on fluid storage holder 100A, 100B effects or causes disengagement of the fluid storage holder 100A, 100B from the equipment. A plurality of fluid storage holders 100A, 100B may be releasably secured to the same piece of gardening equipment and visual indicia, such as coloring, may be provided to provide an indication of the type of fluid contained within each of the fluid storage holders 100A, 100B such that a user or gardener G would readily determine which fluid storage holder 100A, 100B contains, for example, water and which contains, for example, fuel.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. An attachment for a gardening equipment, which includes a cylindrical structure, comprising:
a housing including at least a partially hollow interior defining a reservoir for storing fluid;
a channel formed along a length of the housing;
a pair of protrusions including a first protrusion and a second protrusion, each of the first and second protrusions being juxtaposed relative to one another and extending along a length of the channel; and
wherein the first protrusion and the second protrusion defines a gap therebetween, the gap defining an unbiased width and a second width which is greater than the first width during placement of the cylindrical structure of the gardening equipment within the channel formed along the length of the housing.

2. The attachment of claim 1, wherein:
the housing is formed from a material that is capable of small deflections such that when the cylindrical structure is inserted into the channel, the channel flexes to accommodate the cylindrical structure and grips the cylindrical structure.

3. The attachment of claim 1, wherein:
the housing has a unitary structure.

4. The attachment of claim 1, further comprising:
a pair of opposing protrusions, each of the pair of opposing protrusions extending lengthwise along a length of the channel, the pair of opposing protrusions configured to secure the cylindrical structure within the channel when the cylindrical structure is placed within the channel.

5. The attachment of claim 1, wherein:
the channel defines an arc defining a nadir;
the partially hollow interior defining a reservoir for storing fluid is positioned adjacent to the nadir of the arc and does not extend along opposing sides of the arc.

6. The attachment of claim 1, wherein:
the housing includes a pair of tapered surfaces at opposing ends of the channel, the pair of tapered surfaces tapering toward a midpoint of length of the channel.
